(19) United States
(12) Patent Application Publication
(10) Pub. No.: US 2007/0147249 A1
(43) Pub. Date: Jun. 28, 2007

(54) Cross layer optimization for improving TCP performance in lossy wireless environments

(76) Inventor: Brijesh Kumar, Princeton Junction, NJ (US)

Correspondence Address: GREGORY A. STOBBS, 5445 CORPORATE DRIVE, SUITE 400, TROY, MI, 48098, US

(21) Appl. No.: 11/316,171

(22) Filed: Dec. 22, 2005

(51) Int. Cl. H04J 1/16; H04L 12/56

(52) U.S. Cl. 370/235; 370/389

(57) ABSTRACT

An improved method is provided for reducing packet loss using cross layer information. An exemplary method includes: monitoring a transmission state of a data source, where the transmission state is defined in accordance with TCP; marking data packets with a drop preference at an Internet Protocol (IP) layer of the data packets based on the transmission state; and transmitting the marked data packets from the data source.

### FIELD OF THE INVENTION

The present invention relates to improving TCP performance and, more particularly, to a method for reducing packet loss using cross layer information during data transfer.

### BACKGROUND OF THE INVENTION

Transport control protocol (TCP) uses several mechanisms to avoid congestion, including slow start, congestion avoidance, fast retransmit and recovery, and selective acknowledgement. The packet drops in the path severely reduce the throughput of a TCP source since a packet drop is seen an indication of network congestion. A TCP source, after detecting a packet loss, employs a slow start and congestion avoidance procedure to limit the rate at which packets are sent to the network. A TCP source's internal parameter, transmission window size, controls the number of outstanding unacknowledged packets in the communication pipe between a sender and the receiver. Every time a packet is dropped in the path, a TCP source must follow the slow start and congestion avoidance procedure. This procedure involves reducing the transmission window to just one packet, and then slowly increasing it after an acknowledgement is received from the receiver. Multiple packet losses in a short duration may result in repeated aborting of the recovery procedure, and restarting it again from the initial state of transmission window of just one packet. This can have very serious impact on the throughput of a source. However, currently there is no procedure in the current art that lets a TCP source minimize multiple packet losses, and hence avoid the resulting drastic throughput reduction. A TCP data source currently cannot request any special handling of packets by intermediate packet routing entities along a network path to avoid multiple losses. This inability of the TCP data source may cause unfair distribution of bandwidth among competing sources, especially when a network link is congested and an intermediate routing node can only accommodate a limited amount of network traffic. In this scenario, packets from a TCP data source can be repeatedly dropped by the intermediate routing node making recovery attempts to fail repeatedly and a node can be in the recovery mode for quite sometime. As a result this node can suffer unduly while other nodes may not see any packet loss at all. This scenario is particularly acute in a wireless network environment.

Therefore, it is desirable to provide a method for reducing multiple packet losses for a TCP data source so that each source is able to have its fair share of network bandwidth.

### SUMMARY OF THE INVENTION

In accordance with the present invention, an improved method is provided for reducing packet loss using cross layer information. In one aspect of the invention, the method includes: monitoring a transmission state of a data source, where the transmission state is defined in accordance with TCP's internal state machine; marking data packets with a pre-defined code (e.g., drop preference) at an Internet Protocol (IP) layer of the data packets based on the transmission state; and transmitting the marked data packets from the data source. The code used for marking in the IP header of the data packet conveys the requested handling of the packet at intermediate routing or forwarding entities. In a preferred embodiment, this code may indicate drop preference for the packet with regards to packets from other sources.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a flowchart illustrating a method for reducing packet loss using cross layer information according to the principles of the present invention;

FIG. 2 is a diagram depicting transmission information being passed amongst different layers of the Open System Interconnection model;

FIG. 3 is a diagram depicting the bit format of the DS field; and

FIG. 4 is a flowchart illustrating an exemplary technique for assigning codepoint value in accordance with the present invention.

### DETAILED DESCRIPTION OF THE PREFERRED EMBODIMENTS

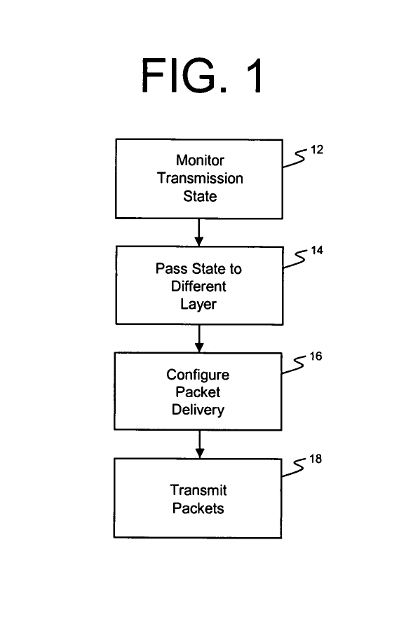

FIG. 1 illustrates a method for reducing packet loss using cross layer information according to the principles of the present invention. In general, a transmission state of a network data source is monitored at step 12, where the transmission state is defined by a communication protocol operating at a transport layer of an Open System Interconnection (OSI) model. The transmission state is then passed at 14 from the transport layer to a layer below the transport layer (e.g., the network layer or data link layer) as defined by the OSI model. In step 16, data packet delivery parameters are configured at the lower layer based on the transmission state received from the transport layer prior to the packets being sent across the network at step 18. In this way, the network can provide fairer distribution of bandwidth amongst data source competing for congested links.

Transport Control Protocol (TCP) is a well known communication protocol that operates at the transport layer (i.e., layer 4) of the Open System Interconnection model. Briefly, TCP enables two hosts to establish a connection and exchange streams of data across a network environment. In addition, TCP provides means which ensure delivery of data between the two hosts. While the following description is provided with reference to TCP, it is readily understood that the broader aspects of the present invention are applicable to other types of communication protocols, such as User Datagram Protocol (UDP), which may operate at the transport layer.

TCP uses several mechanisms to avoid congestion in the network such as slow start, congestion avoidance, fast transmit and fast recovery, and selective acknowledgement. Even though slow start and congestion avoidance are two separate algorithms, in practice they are implemented together. The sender keeps two state variables for congestion control: a slow start/congestion window, cwnd, and a threshold size, ssthresh, to switch between two algorithms. The sender's output routine always sends the minimum of cwnd and the windows advertised by the receiver. ssthresh is initialized to a large value. On a timeout caused due to a packet loss, half the current window size (cwnd) is recorded in ssthresh (this is multiplicative decrease part of the congestion avoidance algorithm), then cwnd is set to 1 packet (this initiates slow start).

When new TCP data is acknowledged, if cwnd is less than ssthresh, cwnd is incremented by 1/cwnd. Thus slow-start opens the windows quickly to what congestion avoidance thinks is a safe operating point, then congestion avoidance takes over and slowly increases the window size to probe for more bandwidth becoming along the network path.

A known problem with the TCP congestion control algorithm is that it allows a potentially inappropriate burst of traffic to be transmitted after TCP has been idle for a relatively long period of time. After an idle period, TCP cannot use the acknowledgement clock to strobe new segments in to the network, as all acknowledgements have been drained from the network. Therefore, as specified above, TCP can potentially send a cwnd-size line rate burst into the network after an idle period. The current standard recommends that a TCP should use slow start to restart transmissions after a relatively long period of inactivity. Slow start serves to restart the Ack clock just as it does at the beginning of a transfer.

TCP throughput is severely affected if multiple packets are dropped when TCP is trying to recover from previous loss. Intuition would suggest that avoiding multiple packet loss for a TCP flow would avoid this severe impact on TCP throughput. In addition, the relationship between packet loss and throughput can be analyzed mathematically. TCP throughput λ, for a flow with TCP's additive increase multiplicative decrease (AIMD) congestion control (increase factor α=1 packet, decrease factor, β=½) can be represented with a simple equation given below:
λ≧S/R√(p)
where S is the packet size and R is the roundtrip time between a source and the destination. From this equation, one can see as p increases throughput will decrease. If on a congested path shared by multiple flows for which S and R are comparable, if we can make p to distribute equally, then each flow will achieve its fair share. The present invention proposes a method for reducing packet loss using a cross layer information transfer mechanism, thereby improving TCP throughput.

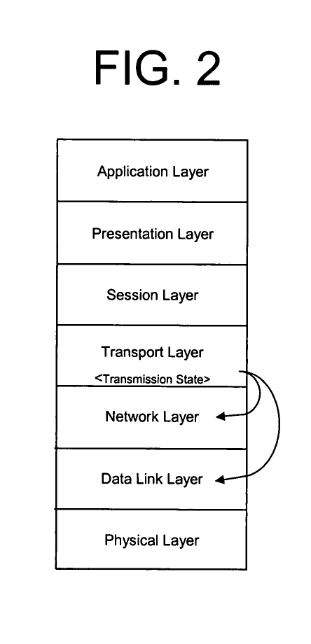

Since each TCP data source maintains its current transmission state, this information may be used to alter the forwarding behavior of data packets sent from the data source. For example, the transmission state is passed from the transport layer to the network layer as shown in FIG. 2. In an exemplary embodiment, an Internet Protocol (IP) is implemented at the network layer. However, it is readily understood that the present invention is applicable to other types of communication protocols which may be implemented at the network layer. At the IP layer, data packets are suitably tagged using the transmission state information from the transport layer so that routing components in the network path apply packet drop policies that minimize multiple packet losses for a given TCP data source.

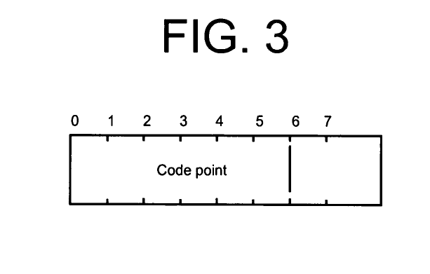

Data packets may be marked in a manner which is similar to a technique employed by the Differentiated Services Architecture. The differentiated services architecture is based on a model where traffic entering a network is classified at the boundaries of the network and assigned to different behavior aggregates. Within the core of the network, packets are forwarded according to the per-hop behavior associated with the applicable behavior aggregate. More specifically, data packets are marked using the DS field in the IPv4 or IPv6 header of the packet. With reference to FIG. 3, the DS field is comprised of a six bit field used to encode a codepoint and a currently unused two bit field, where the codepoint designates the forwarding behavior applied to the packet. By setting the codepoint value, a data source can influence packet forwarding behavior. Further details regarding the Differentiated Services Architecture may be found in RFC 2475 which is incorporated herein by reference.

To mark packets, TCP data source is configured to correlate the transmission state to an applicable codepoint value. For example, when the transmission state indicates that the data source is operating in a congestion control mode (i.e., a slow start state or a congestion avoidance state), then data packets to be sent from the data source are marked with a low drop preference; whereas, when the transmission state indicates that the data source in not operating in a congestion control mode (e.g., operating in a maximum transfer mode or an otherwise normal operational mode), then data packets are marked with a normal drop preference (i.e, marked with best effort forwarding preference). In this example, data packets having a low drop preference are less likely to be dropped than data packets having a normal drop preference.

In an exemplary embodiment, recommended codepoints are used to mark data packets in an assured forwarding per-hop-behavior group. A codepoint, AFny, encodes a class number, n, and a drop preference value, y, within the class. Thus, packets with a codepoint of AF13 will be dropped before packets with a codepoint of AF12 which in turn will be dropped before packets with a codepoint of AF11. Further details regarding the Assured Forwarding PHB Group may be found in RFC 2597 which is incorporated herein by reference.

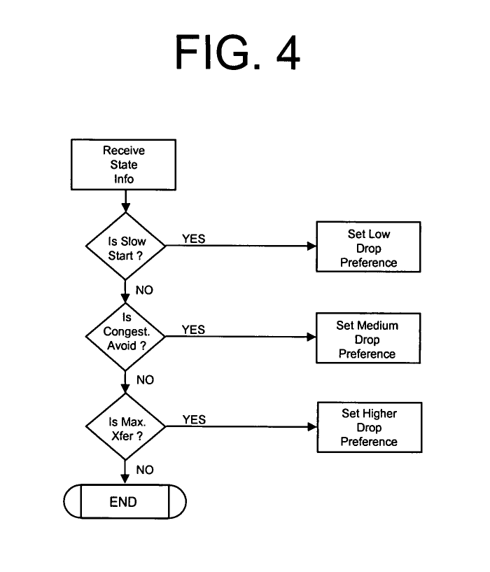

At a network layer, the data source may override the codepoint value assigned to a data packet based on the transmission state passed from the transport layer as shown in FIG. 4. For illustration purposes, when a data source is experiencing a slow start state, the data packets within a first class are marked with a codepoint of AF11, thereby indicating low drop preference. Likewise, when the data source is experiencing a congestion-avoidance mode, the data packets are marked with a codepoint of AF11 or AF12, thereby indicating either a low of medium priority drop preference. When the data source is operating in a normal operational state, then the data packets may be marked with value of AF13 to indicate a higher drop preference. Alternatively, these data packets may retain the previously assigned codepoint value.

Assuming that the routers in the network path use the well known first come first serve (FCFS) queuing discipline, all incoming IP packets on an interface are added to an output queue. If the buffer becomes full due to congestion, the router drops new incoming packets. The marking of packets by the data source can be treated as assured forwarding (AF) PHB marking, and the routers can treat them in the same way. Since it would mean that IP packets sent from a data source experiencing a slow start would be added to the tail of the queue even when the buffer is full. An AF PHB requires a router to free buffer from the output queue by dropping the packets already in the queue that have no such requirements of minimal loss. This would avoid the multiple packet drops for the TCP flow and hence improve the throughput and fairness amongst all TCP flows.

While this exemplary embodiment has modified the codepoint value to altering packet forwarding behavior, it is readily understood that the present invention is not limited to this technique. Rather, it is envisioned that the data packet may be marked in many different ways to obtain preferential treatment along the packet route to improve throughput, quality of service or improving overall communication performance. Moreover, it is envisioned that the cross layer transfer mechanism may be used not only to affect the throughput of a TCP flow, but also to affect other characteristics of network traffic.

A similar technique may also be employed in a wireless network environment experiencing network congestion. In such a network environment, the feedback from the TCP layer can be passed to the IP layer with the payload, and the IP layer, in turn, passes the payload along with the TCP state information to a lower layer as defined by the OSI model. For instance, the TCP state information may be passed to the Media Access Control (MAC) layer. Since packet forwarding occurs at the MAC layer, this layer can use this information to provide better priority, or guaranteed delivery to packets using suitable bandwidth allocation techniques. It is readily understood that the TCP state information may be passed to other layers of the OSI model for similar purposes.

An example of how cross layer information can be used to influence forwarding behavior is to look at the MAC layers of forthcoming ultra-wideband (UWB) wireless technologies or at the MAC protocol for IEEE 802.11 wireless LAN networks. UWB technologies have two competing MAC/PHY proposals: IEEE 802.15.3 MAC and WiMedia UWB MAC. Both these MACs have two operation modes to support two different applications, i.e., real time (RT) media streaming and non-real-time (NRT) data. RT services include audio/video streaming. NRT data services include Web browsing, email, and file transfer. The first transmit operation mode in the wireless MACs is contention mode like contention access period (CAP) in IEEE 802.15.3 MAC or EDCA—Enhanced distributed channel access mode in WiMedia MAC which is similar to Enhanced CSMA/CA with QoS support in IEEE 802.11e. In this mode, devices compete for access to channel and may retransmit in case a collision is detected because many devices transmitting in the same period since no reservation of a wireless channel is done. In some cases, they may leave recovery of the lost packets to higher layer protocols. The second transmission mode is contention free mode like the channel time allocation period (CTAP) in IEEE 802.15.3 MAC or the distributed reservation protocol (DRP) in WiMedia UWB MAC. In the mode, a device makes a reservation of wireless channel before transmitting data to avoid any corruption of the packet. RT services are usually supported by doing a fix time allocation for channel using this mode, but other contention mode can also be used.

In case packet forwarding occurs in the MAC layer only, the cross layer information from TCP can be first passed to IP layer and which in turn can pass this information to the MAC layer along with the payload. The MAC layer can then set the suitable mode depending upon the cross layer information received from the upper layer. For example, when a TCP source requests the low packet drop preference to the IP layer, the IP layer must request the Mac layer to send the pay load only using non-contention mode to guarantee delivery of the packet.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for improving Transmission Control Protocol (TCP) throughput, comprising:
monitoring a transmission state of a data source, where the transmission state is defined in accordance with TCP;
marking data packets with a drop preference at an Internet Protocol (IP) layer of the data packets based on the transmission state; and
transmitting the marked data packets from the data source.

2. The method of claim 1 wherein marking data packets with a drop preference further comprises specifying a drop preference in a differentiated services (DS) field of the data packets.

3. The method of claim 1 wherein marking data packets with a drop preference further comprises designating a low drop preference for data packets when the transmission state is indicative of a congestion control mode, where data packets having a low drop preference are less likely to be dropped than data packets having a normal drop preference.

4. The method of claim 1 further comprises retaining the drop preference of data packets when the transmission state is not indicative of a congestion control mode.

5. The method of claim 1 further comprises designating a normal drop preference for data packets when the transmission state is not indicative of a congestion control mode, where data packets having a low drop preference are less likely to be dropped than data packets having a normal drop preference.

6. The method of claim 1 wherein marking data packets with a drop preference further comprises correlating the transmission state to a codepoint value as defined for an assured forwarding per-hop-behavior group and marking the data packets with the correlated codepoint value.

7. A method for reducing packet loss using cross layer information, comprising:
determining a transmission state of a data source, where the transmission state is defined by a Transmission Control Protocol (TCP);
providing the transmission state from a TCP layer to an Internet Protocol (IP) layer of the data source; and
altering packet forwarding behavior by marking data packets at an IP layer based on the transmission state from the TCP layer, where the data packets are to be transmitted from the data source.

8. The method of claim 1 wherein altering packet forward behavior further comprises marking data packets with a drop preference in a differentiated services (DS) field of the data packets.

9. The method of claim 8 wherein marking data packets with a drop preference further comprises designating a low drop preference for data packets when the transmission state is a slow start state or a congestion avoidance state, where data packets having a low drop preference are less likely to be dropped than data packets having a normal drop preference.

10. The method of claim 8 further comprises retaining the drop preference of data packets when the transmission state is a maximum transfer state.

11. The method of claim 8 wherein marking data packets further comprises designating a normal drop preference for data packets when the transmission state is a maximum transfer state, where data packets having a low drop preference are less likely to be dropped than data packets having a normal drop preference.

12. The method of claim 8 wherein marking data packets with a drop preference further comprises correlating the transmission state to a codepoint value as defined for an assured forwarding per-hop-behavior group and marking the data packets with the correlated codepoint value.

13. The method of claim 7 further comprises transmitting the marked data packets from the data source.

14. A method for reducing packet loss using cross layer information, comprising:
monitoring a transmission state of a data source as defined by a communication protocol operating at a transport layer of an Open System Interconnection (OSI) model;
passing the transmission state from the transport layer to a lower layer below the transport layer as defined by the OSI model; and
configuring packet delivery parameters at said lower layer based on the transmission state received from the transport layer.

15. The method of claim 14 wherein the communication protocol operating at the transport layer is the Transport Control Protocol.

16. The method of claim 14 further comprises passing the transmission state from the transport layer to a network layer.

17. The method of claim 14 wherein configuring packet delivery parameters further comprises altering packet forwarding behavior by marking data packets based on the transmission state and in accordance with an Internet Protocol (IP) operating at the network layer.

18. The method of claim 17 further comprises marking data packets with a drop preference in a differentiated services (DS) field of the data packets.

19. The method of claim 14 further comprises passing the transmission state from the transport layer to a data link layer.

20. The method of claim 14 further comprises passing the transmission state from the transport layer to a Media Access Control layer.
